(19) United States
(12) Patent Application Publication
(10) Pub. No.: US 2015/0302756 A1
(43) Pub. Date: Oct. 22, 2015

(54) METHOD AND DEVICE FOR THE COMBINED SIMULATION AND CONTROL OF REMOTE-CONTROLLED VEHICLES USING A USER-FRIENDLY PROJECTION SYSTEM

(71) Applicant: GRENZEBACH MASCHINENBAU GMBH, Asbach-Baeumenheim (DE)

(72) Inventors: Olaf GUEHRING, Eurasburg (DE); Holger SCHMIDT, Freising (DE)

(73) Assignee: Grenzebach Maschinenbau GmbH, Asbach-Baeumenheim (DE)

(21) Appl. No.: 14/646,578

(22) PCT Filed: Nov. 19, 2013
(86) PCT No.: PCT/IB2013/003244

§ 371 Date: May 21, 2015

(30) Foreign Application Priority Data
Dec. 6, 2012 (DE) 10 2012 023 925.4

(51) Int. Cl. G09B 9/30; G09B 9/12; G09B 5/06; G06F 17/50; G06F 17/10

(52) U.S. Cl. CPC G09B 9/302; G06F 17/5009; G06F 17/10; G09B 5/06; G09B 9/12

(57) ABSTRACT

The invention relates to a device and a method for the combined simulation and control of remote-controlled vehicles in a simulator. A driver's/pilot's compartment comprising real operating elements and emulating the vehicle to be controlled is provided with a six-axis industrial robot connected to ground. A display emulating the contours of the driver's/pilot's compartment serves to convey a simulated view of the exterior. The invention is characterized by the following: a) the vehicle to be controlled transmits to the user of the simulator actual data that are captured by sensors, b) the user of the simulator thus has virtually the same impression of the motion of the vehicle as a real driver/pilot, c) the manner in which the user of the simulator reacts is converted to mechanically picked-up signals, d) a sensor unit mounted in the head region of the user is provided for adjusting the pair of eyes, and e) an apparatus corrects, with the aid of a GPS system in the case of a vehicle that is controlled in reality, the actual position of the vehicle to the calculated position.

The invention relates to a method and a device for the combined simulation and control of remote-controlled. vehicles using a user-friendly projection system.

Flight, simulators or vehicle simulators increase the safety and reduce the costs of the implementation for a real flight. The safety aspects are improved when inexperienced flight school students are learning to fly or less experienced pilots are instructed in operating sequences in conjunction with new vehicles or new techniques.

A device and a method for operating a flight simulator having a particular impression of reality are known from DE 10 2010 035 814 P3, which originates from the applicant itself.

The device described therein, or the corresponding method, is based on the object of proposing a device and a method, using which the operation of a simulator with a particular impression of reality can be achieved for learning to master a vehicle moving in three-dimensional reality, in particular an aircraft. In addition, the possibility is also to exist, for the teacher accompanying the learning operation, of being able to objectively monitor the learning progress and the degree of stress of his student.

To achieve this object, according to patent claim 1, a device is claimed for operating a simulator having a particular impression of reality for learning to master a vehicle moving in three-dimensional reality, wherein a vehicle cabin, which replicates the aircraft to be simulated, having real operating elements is connected to the ground using a six-axis industrial robot, via a support device, which can be implemented as a chassis, and wherein a display screen which replicates the contours of the vehicle cabin is used to transmit a simulated external view. This device is characterized in that it has the following features:
a) the vehicle cabin (4), in addition to the connection to the six-axis industrial robot (1), is connected to the ground via a unit (6) for translational transverse movement, which is mounted on a unit (5) for translational longitudinal, movement so it is movable at a right angle, wherein combined accelerated movements of the two units (6, 5) are enabled, independently of the movements of the industrial robot (1),
b) the display screen which replicates the contours of the vehicle cabin (4) is manufactured on the basis of PLED technology,
c) for simulation of hazardous situations occurring in practice, controllable facilities for artificial smoke generation. (12), shaking movements, sound generation, and light phenomena (14) are provided,
d) to capture human stress reactions, controllable facilities are provided for capturing the skin resistance (10) and detecting personal movements and the physiognomy (16),
e) a sensor (17) for capturing the actual movements of the vehicle cabin,
f) a facility for external operation and control of the simulator, which also registers the reactions of a flight school student.

Furthermore, an autonomous safety system for the user of vehicle simulators or flight simulators and a method. for the safe usage of such simulators are also known from the portfolio of the applicant, from DE 10 2010 053 686 B3. These are based on the object of proposing a device and a method, using which, in addition to mediating operational-technology knowledge of vehicles or aircraft, the safety of the user of a vehicle simulator is also in the foreground in the event of a technical disturbance or an accident.

In patent claim 1, the following is claimed in this regard:

an autonomous safety system for the usage of vehicle simulators or flight simulators in the form of a simulation cockpit (3) actuated by means of a six-axis robot, having the following features:
a) an access region, which is only opened for access of authorized parties, and is secured multiple times at all corners of a safety boundary (9) by means of monitoring sensors (11),
b) a rescue unit (13), which is movable on a slide rail (14) to any location of the operation region of the vehicle simulator, wherein it has a rescue platform (25), a railing (24), and an emergency slide (26),
c) a shock-absorbent surface installed in the entire operation region, wherein it extends over the entire operation region of the cockpit (3),
d) a projection surface (33, 34) composed of multiple planes.

Nonetheless, the operating data transmitted for the respective simulation operation in the vehicle cabin are different from the operating data as occur during real operation of a vehicle, even in the case of a very realistic impression. This is because a real pilot captures with his human senses, consciously or unconsciously, much more than is normally simulated in a vehicle cabin. This is particularly clear in the cases in which autonomous flying objects, so-called drones, are controlled by pilots who actually cause real flight maneuvers.

The present invention is therefore based on the object of providing a device and a method for simulating vehicle movements, using which, above all during actually occurring vehicle movements, the degree of the reality impression is significantly increased for the respective pilots by a user-friendly projection system.

This object is achieved with the features of claim 1,
a device for the combined simulation and control of remote-controlled vehicles in a simulator, wherein a vehicle cabin, which replicates she vehicle to be controlled, having real operating elements is connected to the ground using a six-axis industrial robot via a support device, and wherein a display screen which replicates the contours of the vehicle cabin is used to transmit a simulated external view,
characterized in that it has the following features,
a) a receiving unit for receiving optical data of the vehicle to be controlled, and a receiving unit for receiving acoustic data of the vehicle to be controlled,
b) a transmitting and receiving unit for bidirectionally transmitting movement-relevant data,
c) a control unit, which transmits signals, which are mechanically generated by the user of the simulator, and are prepared by means of mathematical models, to the control elements of the vehicle,
d) a sensor for the adjustment of the pair of eyes of the user with respect to the longitudinal axis of the vehicle cockpit during the projection in she starting location of the vehicle to be controlled,
e) a device for the imperceptible tracking of the mathematically calculated position of the vehicle to the position ascertained by a GPS.

claim 2:
the device as claimed in claim 1,
characterized in that a sensor (8) is installed in the head region of the user to capture the head position, wherein the data thereof influence the viewing direction and/or the image perspective displayed on the display screen.

Claim 3:
the device as claimed in claim 1 or 2, characterized in that the support device of the U six-axis industrial robot is implemented as a chassis.

Claim 4:
the device as claimed in claim 1, 2, or 3, characterized in that the simulation or control is used for vehicles on land, on the water, or in the air.

Claim 5:
the device as claimed in any one of the preceding claims,
characterized in that an AMOLED system or a large projection screen, which is adapted to a cockpit, is used as a visualization element.

Claim 6:
the device as claimed in any one of the preceding claims,
characterized in that a receiving unit is provided for receiving olfactory and/or taste-specific data

and/or a corresponding method according to claim 7:

a method for the combined simulation and control
of remote-controlled vehicles in a simulator, wherein a vehicle cabin, which replicates the vehicle to be controlled, having real operating elements is connected to the ground using a six-axis industrial robot, via a support device, which can he implemented as a chassis, and wherein a display screen which replicates the contours of the vehicle cabin is used to transmit a simulated external view,
characterized in that it has the following features,
a) current data, ascertained by sensors, from the fields of the optics, the kinematics of the movement, and the acoustics are transmitted to the user of the simulator from the vehicle to be controlled,
b) the user of the simulator therefore receives nearly the same impression of the movement operation of the vehicle as a real existing pilot and can react to a current situation according to his experience and/or intuition,
c) the manner of the reaction of the user of the simulator is converted into mechanically recorded. signals, prepared by means of mathematical models, transmitted to the vehicle to be controlled, in case of a real control, and converted therein into real control operations,
d) a sensor is used to adjust the pair of eyes of the user with respect to the longitudinal axis of the vehicle cockpit during the projection in the starting location of the vehicle, wherein its loading is considered,
e) a device tracks the real position of the vehicle imperceptibly to the calculated position by means of a GPS system in the case of a real controlled vehicle.

Claim 8:
the method as claimed in claim 7,
characterized in that a sensor (8) is installed in the head region of the use to capture the head position, wherein the data thereof influence the viewing direction and/or the image perspective displayed on the display screen.

Claim. 9:
the method as claimed in claim 8,
characterized, in that the simulation or the control is used for vehicles on land, on water, and in the air, and in that the transmission of olfactory and/or taste-specific data from the vehicle is provided.

Claim 10:
the method as claimed in claim 8 or 9,
characterized in that the representation of the movements and the visualization are clocked at 60 Hz, and
in that real-time images from a database are overlaid with synthetic images, wherein the resolution thereof can vary between 10 cm/pixel and 15 m/pixel.

claim 11:
a computer program having a program code for carrying out the method steps as claimed in any one of claims 8 to 10 when the program is executed in a computer.

Claim 12:
a machine-readable carrier having the program code of a computer program for carrying out the method as claimed in any one of claims 8 to 10 when the program is executed in a computer.

The invention is based on the idea of making the user of the simulator, by way of transmitting important data from a real moving vehicle, capable-of feeling as if he were actually the pilot, of the respective vehicle. All vehicles which are usable on land, on water, and in the air are considered vehicles in the meaning of the present invention.

Since aircraft are apparently most difficult to control and keep in the air, the invention is described on the basis of the example of aircraft.

Unmanned aircraft systems are also taking over the air space in the civilian realm to an increasing extent. Such flying objects are thus mentioned in the final version of the new Air Traffic Act for Germany. These flying objects, which are usually called drones in the military realm, can fly to locations which humans can only reach with difficulty and are usually less expensive and safer than helicopters. They have the advantage in relation to satellites that they can not only fly to and study specific locations directly and closely, but rather they can also do this multiple times until the desired result is achieved.

However, the load capacity for conventional flying objects of this type is limited and therefore the field of use thereof is still somewhat restricted.

Larger unmanned aircraft systems of this type would currently still require a pilot, however, whose weight would in turn have a negative effect. Notwithstanding this, uses which can result in the loss of human life also exist in the civil realm.

This problem is solved, according to the invention in that already existing flight simulators, such as those mentioned in the introduction to the description, are additionally provided with units, which are equipped to receive data from vehicles to be controlled, for example, from unmanned aircraft systems. In this way, the user of such simulators is made capable of obtaining flight data required for controlling a vehicle in real movement nearly in real time. However, to transmit correction data required for such an active control to the flying object to be controlled, it is additionally provided that movement-relevant data are transmitted, by means of a transmitting station arranged in the region of the simulator, quasi-bidirectionally to the flying object.

Such movement-relevant data are generated by means of mechanical signals which the user of the simulator generates by means of conventionally actuated pedals or side-sticks, and which are transmitted, prepared by means of suitable mathematical models or operations, to the control elements of the respective vehicle. The experience of a simulator pilot and a certain level of intuition obtained from experience are reflected in the timely and correct generation of these signals.

The data transmitted from the vehicle to be controlled, which have an optical, acoustic, or situation-related character, only require a bidirectional nature in this regard in that data are requested at specific intervals or continuously.

The invention will be described in greater detail hereafter on the basis of figures. In detail:

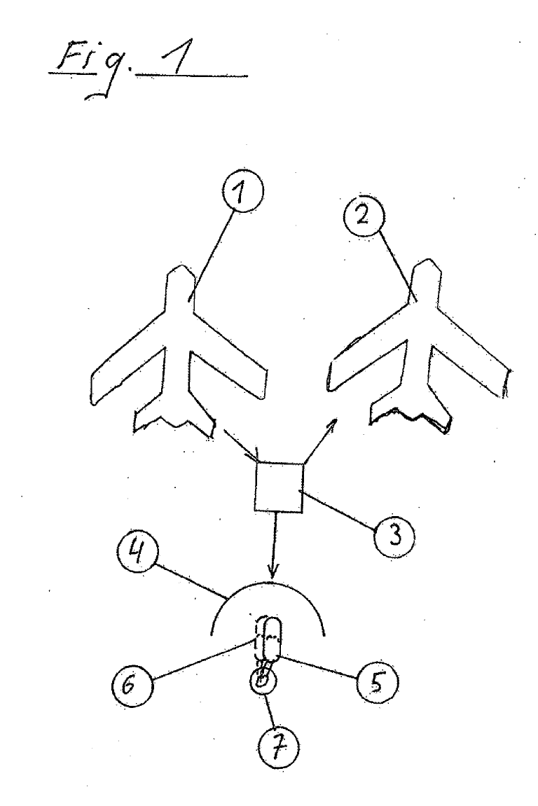

FIG. 1: shows an overview of a flying object. illustration

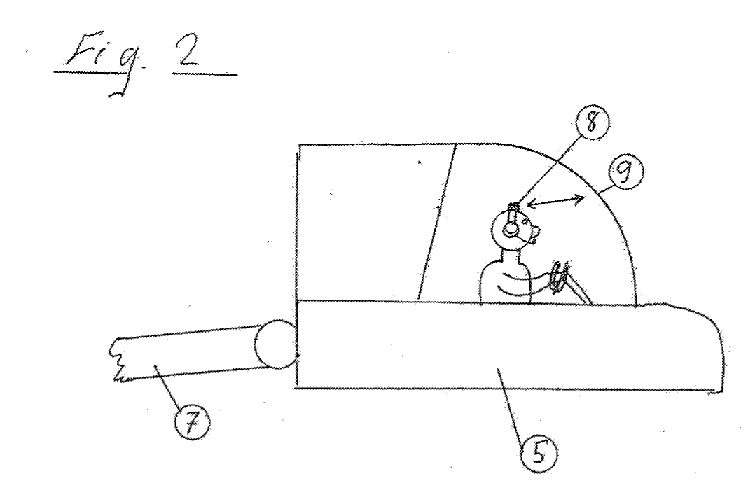

FIG. 2: shows an image of a projection situation

FIG. 1 shows an overview of a flying object illustration. For the user, the procedure of the simulation of a control procedure of a moving vehicle is the same as the procedure of the control of a real vehicle moving in the known 3D world. For the case of the control of a real moving vehicle, it is ensured according to the invention as shown in outline in FIG. 1 that the position of the vehicle, a flying object here, is brought into correspondence on the display screen of the simulator with the position of a flying object in reality. Thus, 1 identifies the real or actual position of a flying object and 2 identifies an assumed position on the display screen of the simulator. A GPS system (global positioning system) is identified with 3, which, as part of the system according to the invention, ensures that the real, actual position of the controlled flying object 1 corresponds to the position on the display screen of the simulator 2. This is particularly significant if real objects are located in the immediate surroundings of the flying object, which can enter into action with the controlled flying object. The user of the simulator does not perceive anything of such procedures of correction of the position displayed on the display screen.

The projection surface of the simulator is identified with 4 in FIG. 1, while the stylistic illustrations 5 and 6 show a calculated position 5 of the flying object shown and 6 shows a position corrected by action of the GPS system. A connection to a six-axis robot of the simulator is indicated by 7.

FIG. 2 shows an image of a projection situation, which represents a further user-friendly feature of the system according to the invention. In this case, the connection to a known six-axis robot is identified by 7 and the position calculated in the simulator, or the simulator itself, is represented by 5.

A head sensor 8 is shown in the headset of the user shown, which detects the instantaneous position of the head and therefore not only displays the viewing direction of the user, but rather also registers the distance of the head from the projection system or the display screen.

These data detected by the head sensor 8 not only enable an adaptation of the spatial region shown on the display screen to the viewing direction of the user, but rather additionally also cause an enlargement or reduction in size of the image detail shown if the head of the user approaches or moves away from the display screen.

A further sensor (not shown in greater detail) is used for adjusting the pair of eyes with respect to the longitudinal axis of the vehicle cockpit for the projection at a standstill. A standstill refers in this case to the starting location of a remote-controlled. vehicle. This starting location differs depending on the location of the center of gravity of a vehicle, wherein the center of gravity primarily changes with the loading of a vehicle.

Furthermore, a so-called simulation model 80/20 is used according to the invention. This means that the impression of reality or the perception of the authenticity of the overall impression is achieved approximately 80% by the visualization and approximately 20% by the representation of the movement. During the representation of rapid and large-scale movements this ratio shifts accordingly in favor of the movement.

Mathematical models for water, land, and air are conceivable.

Mathematical models can be smoothed for extreme movements. The stresses for the user therefore remain in the customary framework.

The movements and the visualization are clocked at 60 Hz and can be replaced by real-time data at any time.

Furthermore, superimposed images can be created by a method referred to as synthetic vision. In this case, real-time images from the database can be superimposed with synthetic images. The resolution thereof can vary between 10 cm/pixel and 15 m/pixel.

The visualization during the representation in the simulator can be performed via so-called AMOLED systems (active matrix organic light-emitting diode), which is adapted to the size of the visible area from a flying object, or using a large projection screen which can have an image surface of up to 155 m².

The images from the vehicle are relayed in real time to the operating station. The system is controllable both from the vehicle cockpit and also from an operating station.

All CE guidelines are fulfilled with regard to the safety requirements.

Furthermore, a receiving unit can also he provided for receiving olfactory and/or taste-specific data, which simulate, for example, the smell of fire and/or the taste of air particles.

The control of the complex movement procedures and the signal processing of the sensors used require a special control program.

### LIST OF REFERENCE NUMERALS

1 flying object, real position
2 flying object, calculated position
4 projection surface
5 position calculated in the simulator
6 position corrected in the simulator
7 six-axis robot.
8 head sensor
9 AMOLED projection system

1. A device for the combined simulation and control of remote-controlled vehicles in a simulator, wherein a vehicle cabin, which replicates the vehicle to be controlled, having real operating elements is connected to the ground using a six-axis industrial robot via a support device, and wherein a display screen which replicates the contours of the vehicle cabin is used to transmit a simulated external view, the device comprising:
a) a receiving unit for receiving optical data of the vehicle to be controlled, and a receiving unit for receiving acoustic data of the vehicle to be controlled,
b) a transmitting and receiving unit for bidirectionally transmitting movement relevant data,
c) a control unit, which transmits signals, which are mechanically generated by the user of the simulator, and are prepared by means of mathematical models, to the control elements of the vehicle,
d) a sensor for the adjustment of the pair of eyes of the user with respect to the longitudinal axis of the vehicle cockpit during the projection in the starting location of the vehicle to be controlled,
e) a device for the imperceptible tracking of the mathematically calculated position or the vehicle w the position ascertained by a GPS.

2. The device as claimed in claim 1, wherein sensor (8) is installed in the head region of the user to capture the head position, wherein the data thereof influence the viewing direction and/or the image perspective displayed on the display screen.

3. The device as claimed in claim 1, wherein the support device of the six-axis industrial robot is implemented as a chassis.

4. The device as claimed in claim 1, wherein the simulation or control is used for vehicles on land, on the water, or in the air.

5. The device as claimed in claim 1, wherein an AMOLED system or a large projection screen, which is adapted to a cockpit, is used as a visualization element.

6. The device as claimed in claim 1, wherein a receiving unit is provided for receiving olfactory and/or taste-specific data.

7. A method for the combined simulation and control of remote-controlled vehicles in a simulator, wherein a vehicle cabin, which replicates the vehicle to he controlled, having real operating elements is connected to the ground using a six-axis industrial robot, via a support device, which can be implemented as a chassis, and wherein a display screen which replicates the contours of the vehicle cabin is used to transmit a simulated external view, said method comprising:
f) current data, ascertained by sensors, from the fields of the optics, the kinematics of the movement, and the acoustics arc transmitted to the user of the simulator from the vehicle to be controlled,
g) the user of the simulator therefore receives nearly the same impression of the movement operation of the vehicle as a real existing pilot and can react to a current situation according to his experience and/or intuition,
h) the manner of the reaction of the user of the simulator is converted into mechanically recorded signals, prepared by means of mathematical models, transmitted to the vehicle to be controlled, in case of a real control, and converted therein into real control operations,
i) a sensor is used to adjust the pair of eyes of the user with respect to the longitudinal axis of the vehicle cockpit during the projection in the starting location of the vehicle, wherein its loading is considered,
j) a device tracks the real position of the vehicle imperceptibly to the calculated position by means of a GPS system in the case of a real controlled vehicle.

8. The method as claimed in claim 7, wherein a sensor (8) is installed in the head region of the user to capture the head position, wherein the data thereof influence the viewing direction and/or the image perspective displayed on the display screen.

9. The method as claimed in claim 8, wherein the simulation or the control is used for vehicles on land, on water, and in the air, and in that the transmission of olfactory and/or taste-specific data from the vehicle is provided.

10. The method as claimed in claim 8, wherein the representation of the movements and the visualization are clocked at 60 Hz, and
in that real time images from a database are overlaid with synthetic images, wherein the resolution thereof can vary between 10 cm/pixel and 15 m/pixel.

11. A computer program having a program code for carrying Out the method steps as claimed in claim 8, when the program is executed in a computer.

12. A machine-readable carrier having the program cube of a computer program for carrying out the method as claimed in claim 8, when the program is executed in a computer.
